(19) United States
(12) Patent Application Publication
(10) Pub. No.: US 2025/0348853 A1
(43) Pub. Date: Nov. 13, 2025

(54) WASTE ANALYSIS AND CERTIFICATION STATION AND METHOD FOR WASTE TREATMENT

(71) Applicant: UpCircle Technology AG, Zürich (CH)

(72) Inventor: Hendrik René KOLVENBACH, Zürich (CH)

(73) Assignee: UpCircle Technology AG, Zürich (CH)

(21) Appl. No.: 18/860,215

(22) PCT Filed: Apr. 14, 2023
(86) PCT No.: PCT/CH2023/050010

§ 371 Date: Oct. 25, 2024

(30) Foreign Application Priority Data
Apr. 28, 2022 (CH) CH000498/2022

(51) Int. Cl. G06Q 10/30

(52) U.S. Cl. CPC G06Q 10/30

(57) ABSTRACT

A waste analysis and certification station provides fully automated waste analysis and certification for verifying waste recovery for recycling and/or verifying the legitimacy of the recovery process, with different units fully controlled by an electronics, which automatically monitors and certifies the waste so that the certificates and/or the certified material can be securely sold. The station includes an automated transport unit, a subsequent connected sensing unit with a sensor, most preferred a camera, recording images, a subsequent detecting and certification unit effect-connected to a computational unit, a storage and display unit where certified data of each collected certified waste item is saved and made securely online accessible in an online database to the public and a waste collection and a guiding to a waste treatment process for recycling or destruction.

### TECHNICAL FIELD

The present invention describes a waste analysis and certification station to verify the legitimacy of a collection and recycling process or trace waste material wherein different units are controlled by electronics and an automated method for waste analysis and certification.

### STATE OF THE ART

It has recently become clear that the pollution of the world's oceans, especially by plastic waste, has taken on enormous proportions. The waste ends up in the sea because rivers transport waste from illegal dumpsites and other leakages that highlight the issue of mismanaged waste. Therefore, the goal must be to prevent further waste accumulation in the environment by recovery and collection for further processing. However, a key driver of environmental pollution today is a lack of collection points for mixed plastic waste, where waste can be disposed of, quantified, and certified to pay the waste collector appropriately. In this context, ready-made solutions are not yet commercially available.

On the other hand, many international companies want to engage in sustainability initiatives and invest in environmental certificates. Such companies are, for example, interested in offsetting their plastic footprint by paying for plastic recovery (“plastic credits”) or partly want to use recycled river-bound or ocean-bound plastic in their products such as Patagonia, Adidas, Coco-Cola, and others. Those efforts are needed because a growing customer segment demands sustainably produced products and companies that intend to fulfill this need. Nevertheless, financing environmental protection has always been a problem due to a lack of transparency, as it has been identified in the carbon offsetting market. A fully transparent collection and certification of waste can create added value here, which is financed by customers who do not have to be involved in the waste collection process themselves.

We are dealing with two issues here, proving that waste is recovered from the environment, potentially as a service and certifying the source of the material itself for further processing and reporting the information to companies or government agencies. The first is crucial as it allows companies and governments to offset their emissions by financing recovery or cleanup operations of waste, that would otherwise leave the recycling chain. The latter is attractive to manufacturers who want to use the certified materials for their products.

So far, the acquisition of waste, of which the majority is plastic, is made manually. If a waste certification takes place at all, it is issued in an intransparent manner, relying heavily on the sincerity of the certificate issuer. This seems to be why hardly any providers engage with waste disposal, and waste certificates are not in great demand either.

### Point 1: Verifying Ocean-Bound Waste for Manufacturing

Consulting companies such as “Southpole” provide supply-chain tracking of recycled material for plastic goods manufacturers. This is generally done by third-party auditing the supply chain, which takes a lot of effort and time and is not transparent. The buying party must trust the material collectors or the third party auditing company.

Solutions in this space depend on sustainability labels but are hard to get, and the number of certified companies is negligible.

### Point 2: Verifying the Legitimacy of the Recovery Process

There is a growing market demand for offsetting plastic production and consumption. However, companies interested in offsetting their emission find it challenging to find trustworthy offsetting credits to buy. Credit accreditation entities such as “Verra” certify the creation and trading of plastic credits. Other solutions, such as those offered by “Repurpose” and “Cleanhub” create a market connecting collector-recyclers to companies that want to offset emissions. These credits are created manually by people scanning the recovered items and taking “proof” photos with their smartphones. Their approach works only on a labor-intensive, trust-based system, where people should not take pictures of the same item more than once.

The company “Everwave” operates a river cleaning machine to extract river debris. All their records are created manually. However, this includes all waste (plastics, non-plastic trash, and non-trash organic material). Their platform functions in a trust-based transaction, where no proof is directly accessible to the buyer as a product.

### DESCRIPTION OF THE INVENTION

The object of the present invention is to create a fully automatic waste analysis and certification station, where collected waste can be inserted, monitored, analyzed up to item level, and certified, wherein the certificates or the certified recycled plastic can be sold.

With our invention, the certification of recovered waste items is fully automated and transparent so that buyers can rely on the equivalent value of the certificates or the waste collected if such buyers want to use certified recycled waste.

Our invention further allows us to monitor waste items at all value chain stages, from the material's acquisition to the delivery destination at a local waste management facility, local recycling plant, or other final destination.

Our implementation operates autonomously and significantly decreases manual labor while adding transparency and waste insights. Our solution also removes the human as a potential error source from the system and creates a unified waste classification. Additionally, the detection, analysis and credit generation pipeline is automated and standardized in our solution, reducing the chance of fraud and increasing the speed of generating credits.

Furthermore, the transparent data will be useful for countries with EPR (Extended Producer Responsibility) schemes to track and trace the objects in the waste streams, and understand the composition of waste and facilitate the payments of the producers accordingly.

### BRIEF DESCRIPTION OF THE DRAWINGS

Further understanding of various aspects of the invention can be obtained by reference to the following detailed description in conjunction with the associated drawings, which are described briefly below.

In the differently described embodiments, the same parts are provided with the same reference symbols or the same component names, the disclosures contained in the entire description being able to be applied analogously to the same parts with the same reference symbols or the same component symbols.

A preferred exemplary embodiment of the subject matter of the invention is described below in conjunction with the attached drawings.

FIG. 1a shows a schematic view of a waste analysis and certification station with extraction unit, transport unit, sensing unit, detecting unit, certification unit and waste collection, while

FIG. 1b shows a typical image produced in the sensing unit, while detection step, while

FIG. 1c shows a resulting schematic view of certified waste items in an online database.

### DESCRIPTION

We are presenting a waste analysis and certification station, a method for analyzing and certifying waste objects, here extracting waste items W from a river R as an example. Of course the waste could be extracted from households, industrial plants and waters in general. Before further treatment, the waste items are collected, detected, identified, and certified with associated unique identifiers. Our waste analysis and certification station and method can operate automatically or with minimal human intervention.

Other waste sources can be household and the waste analysis and certification station could work in Material Recovery Facilities (MRFs), or any other place were waste is aggregated or processed.

The method offers complete tracking of individually identified waste items collected, from the moment it is returned to when it gets added to a batch or waste collection for processing in a recycling facility.

The advantage of our method is the reduction of third-party audition dependency because a digital proof of waste items retrieved is generated and accessible, for example, through an online platform.

Such waste analysis and certification stations can work autonomously under minimal surveillance and maintenance efforts. Since it is way less labor-intensive than current solutions, it can also be applied in high-income countries to save labor costs and enhance reporting capabilities for EPR schemes. Our waste analysis and certification station and method are also scalable since it only requires the analysis and detection system for the certification process. It can thus be integrated into current solutions provided by other market competitors and benefit from the network effect.

The goal is to issue the waste recovery certificates (“Plastic credits” or their EPR equivalent) mentioned above and sell them to larger companies as proof of recovery service. Linking them to the CO2-certificate market will greatly up-scale the idea's potential since the CO2-compensation market is a 1 B$/annum business and rising. The global voluntary carbon market grew by 6% in 2019, reaching a total transaction value of $320 million.

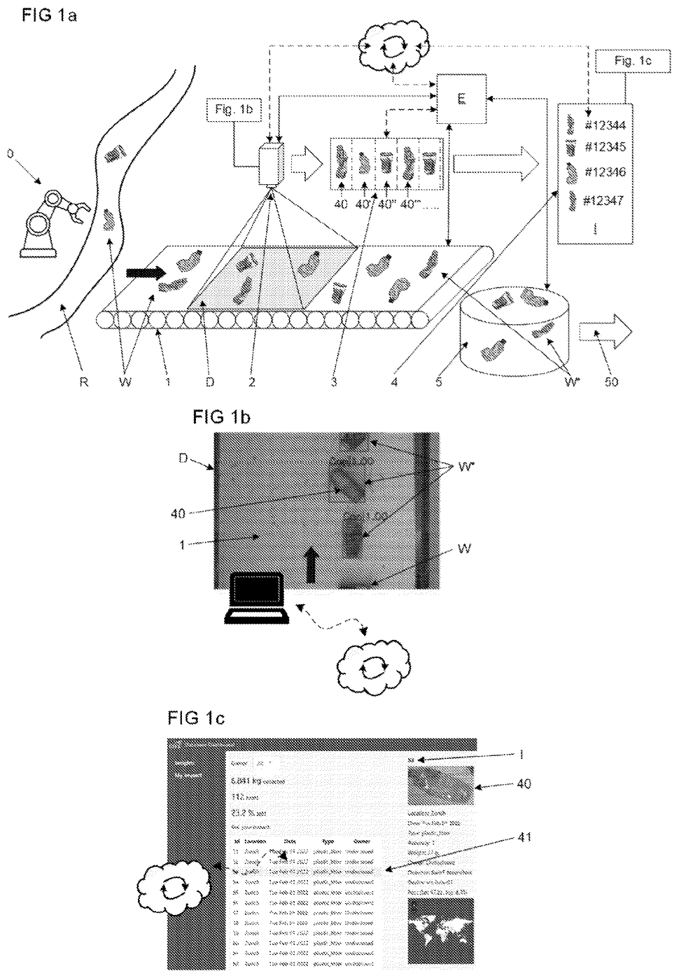

The waste analysis and certification station is fully automatic. A preferred embodiment comprises a control electronics E, an optional extraction unit 0, a transport unit 1, a sensing unit 2, a detecting and certification unit 3, a storage and display unit 4, and a waste collection 5. The control electronics E is connected to the single units, achieving control of the entire process, including certification. Most preferred is a computational unit integrated into the electronics E or connected with a cloud, as indicated in FIG. 1a, to analyze and certify waste items, as explained below. If a cloud is used, the sensing unit 2, the detection unit 3, and the storage and display unit 4 can be directly connected or mapped in the cloud. The connection between this units 2, 3, 4 can than be created only via the cloud.

The possible extraction unit 0 can be formed as a robotic system, preferred comprising an actuator or a robotic arm or an automatic robotic sorting stage, which is here extracting waste items W from river R. The robotic system can be based on at least one pneumatic actuator. The extraction unit 0 should have technical features to allow automated operation, which is known to the skilled person. Other embodiments of the extraction unit 0 are conceivable, for example, a conveyor belt or even a manual placement is possible. At the moment, manual adding is our preferred method of execution, whereby we use a hopper or similar into which objects are dropped and thus directed onto the belt. Of course, an automatically collection and feeding in transport unit 1 is most preferred.

We are showing in FIG. 1a a feeding of waste items W onto a transport unit 1, which is solved here as shown as an automatically controlled conveyor belt 1. The conveyor belt 1 moves the waste items W through a detection area D, which is observed by a sensing unit 2 with at least one sensor, usually at least a camera C, which is mounted fixed to view the surface of the detection area D of the conveyor belt 1. The sensing unit 2 is coupled with the electronics E, providing the recorded images for later analysis. Such sensors or cameras C allow image capture with electromagnetic waves of different wavelengths. The images are fed into the detection and certification unit 3, where an object classification respectively, identification and subsequent certification will be performed.

The detection and certification unit 3 can be integrated into the electronics E or could be outsourced into the cloud by necessary and known means.

A typical detection image of camera C as sensor is shown in FIG. 1b, where visible light was used, showing different kinds of waste W, exemplary here plastic bottles and metal cans, detected by the sensing unit 2, which is connected to the control electronics E. In the detection area D, as part of the transport unit 1, the sensing unit 2 identifies random waste items W with the camera C and records images 40.

Before the detection area D, the collected waste items W were collected and placed on the conveyor belt 1, not shown in FIG. 1b. In contrast, the conveyor belt 1 moves the waste items W and later analyzed and certified waste items W* in the direction of the black arrow.

Images of the detected objects W of the sensing unit 2 will be further processed in the detecting and certification unit 3. The subsequent detecting and certification unit 3 is effect-connected to a computational unit, preferably part of the electronics E. The computation for detection and/or certification can also occur in the cloud respectively in a computational unit with software in the cloud.

After the sensing step in the detection area D, the detecting and certification step in the detection and certification unit 3 follows. Waste items W are identified via software algorithms and afterward certified via software algorithms in the detecting and certification unit 3, whereby the waste items W become the certified waste items W*. For each detected waste item W, at least one image 40 and an associated unique Identifier I is saved, optionally with additional meta-information 41 per certified waste item W*.

In the detecting and certification unit 3, data analysis of the images 40, 40′, 40″, 40′″ automatically takes place.

Such analysis can be done by a detecting algorithm, detecting the kind of waste and optional additional meta-information in images 40, 40′, 40″, 40′″ of waste items W. The detecting and certification unit 3 is usually a part of the electronics E and assigns to each image 40, 40′, 40″, 40′″ respectively waste item W and unique Identifier I.

Such unique Identifier I will be generated for each detected waste item W for example, by consecutive numbers, locally in the electronics E, here #12344 to #12347 by simple counting.

In another embodiment, the generation of the unique Identifier I can be carried out remotely in the cloud through appropriate algorithms. Appropriate algorithms for detecting and/or generating the unique Identifier I can be based on or using neural networks. Preferably a specifically trained neural network can be used in the detecting and certification unit 3 as part of the electronics E or in the cloud for achieving unique Identifier I and meta-information 41.

The unique Identifier I proves the collected and certified waste item W*, and optional meta-information 41 provides additional information. It has proven good to combine camera data and meta information in a cryptographic hash, which can be generated and/or saved locally or remotely.

Besides a local execution of the detecting and certification step, the detecting and certification unit 3 could be part of the cloud, respectively the detecting algorithm is running online in the cloud, with or without using neural networks, indirect on at least one server connected via wire or wireless, which is building the cloud. Data of the camera C are then streamed to the cloud for further processing. Such a cloud is indicated in the figures by the typical icon.

Meta-information 41 could be, for example, type of waste (cardboard, foil, PET bottle, aluminum can, etc.), brand information, producer information, product label, material, volume, weight, foodgrade, date/time of extraction or recovery, location of recovery, resulting in certified waste items W* in the detection and certification unit 3. As explained in FIG. 1a, for each certified waste item W*, an image 40, meta-information 41 and a unique Identifier I are processed and saved in the detection and certification unit 3, which could be a cloud, usually forming part of the electronics E.

The collected images 40, 40′, 40′″ . . . , associated unique Identifier I and optional meta-information 41 can be defined as certified data, each associated with a certified waste item W*. Such certified data proves that waste items W were collected or processed and the certified waste items W* were, after collection and certification, further processed via the waste collection 5 to a waste treatment process 50, like following sorting steps, further recycling processes, (co-)processing in an incineration plant, pyrolysis and other. In a modified version, the certified waste item W* can be directly fed into a waste treatment process 50, without prior storage in a waste collection 5.

The certified data is saved in a database and provided online, accessible via the storage and display unit 4 in an online database as shown in FIG. 1c. The gathered data of certified waste items W*, image 40, unique Identifier I and meta-information 41 are the digital recovery-proof or recycling proof and are used for issuing a certificate. Such certificate is publicly retrievable; the authenticity is traceable, and the data is unchangeable from the outside and therefore securely billable. The ownership of the digital recovery-proof or recycling proof, respectively, and the certificate can be transferred and/or associated with a customer or used to inform an EPR agency of the recovery or recycling operation.

To store the certificates of certified waste items W* in a tamper-proof manner via the detecting and certification unit 3, such storage and display unit 4 can be a local computer system storing and displaying data or the storage could be a blockchain or blockchain-based technology (for example Non-Fungible Tokens (NFT)) which secured data can be shown online via the cloud.

Instead of or in addition to using a camera in the visual spectrum as part of the sensing unit 2, detecting the waste items W, other sensors could be used. Namely, Infrared type sensors, spectrometers, depth sensors, and others. Those other sensors can provide redundant and/or additional information, such as the material composition of the detected objects.

Instead or in addition to a fixed mounted sensing unit 2, a movable sensing unit 2 may be used, for example, a smartphone with at least one camera, as part of the portable sensing unit 2.

Instead of or in addition to generating a unique identification, the data can be used for the analysis of environmental pollution and composition of certified waste items W*.

Instead of or in addition to generating unique identification in the form of certified data, the certified data can be used for evaluation and determination of types of waste or can be linked to the savings in CO2-emissions and therefore the process can be used to issue CO2 certificates additionally.

Governments and policymakers are implementing more and more EPR (Extended Producer Responsibility) schemes. A fundamental aspect of EPR is the reporting and monitoring, whereby Producers must report on the amount of products they sell and the amount that is collected and recycled, and the government monitors compliance with the EPR scheme. A process which is up till today highly intransparent (e.g. a brand might not pay into an EPR scheme while others are, and/or a recycler is processing different waste than what a producer technically paid for). The data provided can be used to generate highly transparent EPR data.

### LIST OF REFERENCE NUMERALS

0 Extraction unit (robotic sorting stage, manual or by robotic system)
1 transport unit/conveyor belt
D detection area
2 sensing unit
C camera (visual, different wavelengths)
3 detecting and certification unit
4 storage and display unit
40 image
I unique Identifier
41 meta-information
5 batch/waste collection (in container)
50 waste treatment process=recycling or incineration
E control electronics (data storage, . . . )
R river
W waste item
W* certified waste item

1-15. (canceled)

16. A waste analysis and certification station for verifying the legitimacy of a collection and recycling process and/or tracing of waste material wherein different units are controlled by an electronics, the waste analysis and certification station comprising:
a transport unit in form of a conveyor belt for transport, automated with the electronics,
a subsequent connected sensing unit with a sensor, most preferred a camera, records images of waste items for further processing,
a subsequent detecting and certification unit effect connected to a computational unit, which is preferably part of the electronics, wherein waste items are identifiable by the image and at least one associated unique identifier are assigned via software algorithms,
a storage and display unit where certified data of each collected certified waste item in form of the images and the at least one associated unique identifier is finally saved and made securely online accessible in an online database and subsequent feeding of certified waste items to a waste treatment process for recycling or destruction,
wherein the sensing unit, detecting and certification unit and/or storage and display unit are each connected to the electronics or are mapped in the cloud.

17. The waste analysis and certification station according to claim 16, wherein the extraction unit is a robotic system comprising at least one actuator, preferred a robotic arm or a further conveyor belt, effect-connected to the electronics.

18. The waste analysis and certification station according to claim 16, wherein the sensing unit respectively the camera of the sensing unit is fixed in position relative to the transport unit, working in the visual spectrum.

19. The waste analysis and certification station according to claim 18, wherein the conveyor belt moves the waste items through a detection area, observed by the fixed sensing unit.

20. The waste analysis and certification station according to claim 16, wherein instead or in addition to a visible light camera an infrared type sensor, a spectrometer or at least a depth sensor forms the sensor of the sensing unit.

21. The waste analysis and certification station according to claim 16, wherein data analysis of images and assignment of associated unique identifier is automatically achieved in the detecting and certification unit by detecting algorithm creating cryptographic hashs and can be carried out locally or remote in the cloud.

22. The waste analysis and certification station according to claim 21, wherein at least one neural network is used in the detecting and certification unit for achieving the unique identifier and additional meta-information of the waste items, wherein such data are saved in the detection and certification unit locally or remote in the cloud.

23. The waste analysis and certification station according to claim 22, wherein the meta-information is at least one of type of waste, brand information, producer information, product label, material, volume, weight, date/time of extraction, foodgrade, and location of recovery of the analyzed waste items.

24. The waste analysis and certification station according to claim 22, wherein by the detecting and certification unit the gathered certified data of certified waste items like image, unique identifier and meta-information are the digital recovery-proof and are used for issuing a certificate, which is publicly retrievable, wherein authenticity is traceable and the certified data is unchangeable from the outside and therefore securely billable.

25. The waste analysis and certification station according to claim 24, wherein the certificates of certified waste items are stored on a blockchain or used to generate blockchain-based tokens.

26. An automated method for waste analysis and certification, the method comprising:
placing waste items on the transport unit of the waste analysis and certification station according to claim 16, wherein the transport unit is in form of a conveyor belt,
recording of image data of waste items with the sensing unit in a detection area on the conveyor belt,
subsequent identification and certification of images,
resulting in certified data of each recovered waste item,
assigning at least one associated unique identifier via software algorithms in the detecting and certification unit locally or remote in the cloud,
saving of certified data of each collected certified waste item in form of the images and/or their at least one associated unique identifier and making securely online accessible in an online database via the software controlled storage and display unit locally or remote in the cloud, before
collected certified waste items are fed to a waste treatment process for recycling or destruction.

27. The method according to claim 26, wherein waste items are recovered by an extraction unit, which comprises manual adding of waste items via a hopper onto the transport unit.

28. The method according to claim 26, wherein the storage and display unit can be a local computer system or the storage could be a blockchain or blockchain-based token technology, like for example Non-Fungible Tokens, to make secured data accessible.

29. The method according to claim 26, wherein from the certified data collected determination of types of waste takes place, which is published online and/or possible savings in CO₂ emissions will be determined for additional issuing CO₂ certificates.

30. The method according to claim 26, wherein the certified data collected is connected to an EPR (Extended Producer Responsibility) scheme or implementation partner, whereby the partner is informed about the composition of the retrieved waste meta-information, wherein the meta-information is at least one of type of waste, brand information, producer information, product label, material, volume, weight, date/time of extraction, foodgrade, and location of recovery of the analyzed waste items.
